(19) United States
(12) Patent Application Publication
(10) Pub. No.: US 2009/0225322 A1
(43) Pub. Date: Sep. 10, 2009

(54) SELECTION OF INTERROGATION WAVELENGTHS IN OPTICAL BIO-DETECTION SYSTEMS

(75) Inventors: Philip D. Henshaw, Carlisle, MA (US); Pierre C. Trepagnier, Medford, MA (US); Matthew B. Campbell, Annandale, VA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SPARTA, INC., Billerica, MA (US)

(21) Appl. No.: 12/116,682

(22) Filed: May 7, 2008

Related U.S. Application Data
(60) Provisional application No. 60/916,480, filed on May 7, 2007.

(51) Int. Cl. G01J 3/45

(52) U.S. Cl. 356/451

(57) ABSTRACT

Methods and systems are disclosed for selecting a set of interrogation wavelengths from spectral data, the method including the steps of performing a principal coordinate transformation on the spectral data, choosing an objective function which describes the efficiency of the transformation in separating the class of agents from the class of interferents, rank ordering the interrogation wavelengths according to said objective function, and choosing the set of wavelengths with the highest rank. In one preferred embodiment, the objective function is the smallest spectral angle between the class of agents and the class of interferents.

### RELATED APPLICATION

This application claims priority to a provisional application entitled “Selection of Interrogation Wavelengths in Optical Bio-detection Systems,” having a Ser. No. 60/916,480 and filed on May 7, 2007. This provisional application is herein incorporated by reference in its entirety.

The present application is also related to a commonly-owned patent application entitled “Population Of Background Suppression Lists From Limited Data In Agent Detection Systems” by Pierre C. Trepagnier and Philip D. Henshaw filed concurrently herewith (Attorney Docket No. 101335-35). Both the concurrently filed application and its priority document, U.S. Provisional Patent Application No. 60/916,466, filed May 7, 2007, are incorporated herein by reference in their entirety.

### U.S. Government Rights

This invention was made with U.S. Government support under contract number HR0011-06-C-0010 awarded by the Department of Defense. The government has certain rights in the invention.

### BACKGROUND OF THE INVENTION

The present invention is related generally to methods and systems for optical detection of agents such as pathogens or toxic substances and, in particular, to methods and systems for selecting preferred wavelengths for optical interrogation of samples.

Detection of bio-aerosol warfare agents in the presence of either indoor or outdoor backgrounds is a difficult problem. Natural backgrounds are variable, with multiple constituents present at the same time, and the variation of each constituent may be larger than the level of agent that one wishes to detect. The problem can be exacerbated by the presence of naturally-occurring background of spikes, which may last for minutes and exhibit large variations in particle count, and which may be an order of magnitude larger than the normal quiescent background. These varying backgrounds typically create false alarms, which in turn create problems for a bio-aerosol detection system. Repeated false alarms will cause people to panic or begin to ignore warnings. High regret actions, such as building evacuation or administering antibiotics are expensive and intrusive, especially if they occur often.

To mitigate these problems, some bio-aerosol detection systems comprise a trigger plus a confirmation sensor. The trigger is a low-cost, non-specific detection system that runs continuously. The confirmation sensor has high specificity for identifying specific bio-agents, and runs only when it is triggered. Typically, confirmation sensors are expensive to operate relative to trigger sensors, and may have logistics requirements for reagents, fluid consumption, etc. A high trigger false alarm rate will drive up the confirmation sensor operating cost. Typically, confirmation sensors will also take longer to provide a result than a trigger sensor. Thus, a trigger sensor with low false alarm rate may be used for low regret actions that need to be taken quickly to be effective such as temporary shut down of a building heat/ventilation/air conditioning system.

One approach to a trigger sensor is to collect a bulk sample, immobilize it, and perform high-dimensional measurements of some property of the sample. For example, the high-dimensional space may be the spectrum of reflected or transmitted radiation or the emission spectrum of fluorescence induced by short wavelength illumination. The high-dimensional space may also be the result of concatenated spectra from separate measurements, such as the fluorescence excited by different illumination wavelengths.

For ease in terminology, in general we will refer to that which we are trying to detect as “agents,” and the backgrounds which may be mistaken for agents and cause false alarms as “interferents.” These terms generalize beyond the specific domain of bio-aerosol detection.

Detection of other important agents shares some of the difficulties of detection of bio-aerosols. For example, chemical warfare agents may need to be detected in the presence of industrial cleaners or insecticides. Nuclear materials may be hidden by background radiation from rocks and cements, as well as by residual radiation from medical treatment or radiation from shipments of medical equipment. Explosives traces can be mimicked by foods preserved with nitrates, and as well as by legitimate shipments of fertilizers, which can act as interferents in this problem domain. Detection of pollutants and contaminants share the same problems as detection of biological, chemical, and radiological warfare agents. All these problems require detection at low levels in the ambient environment. Detection sensitivity can be increased by concentrating the sample to be analyzed, but at the risk of having both large amounts of background and small amounts of agent in the same sample.

Some workers in the field have attempted to solve the false-alarm problem by finding signatures that are unique to the agents being sought. This normally requires that signatures of agents and background constituents be unique and non-overlapping. This approach may work with signatures that have many very narrow features, such as LIBS (Laser Induced Breakdown Spectroscopy), Raman spectra, and FTIR (Fourier Transform Infrared) spectra. However, it is not suitable for signatures that have broad features, such as UV-induced fluorescence spectra and lifetime, x-ray fluorescence spectra, and terahertz (THz) spectra.

A brute-force way of being certain that one has the maximum possible information is to simply acquire fluorescence data over essentially the complete relevant spectral space. However, this approach is costly and time-consuming, particularly because generation of many different excitation wavelengths is difficult and expensive. In the bio-aerosol example, generating excitation wavelengths at 20 nm increments over the relevant excitation space, where the most important part extends roughly from 215 to 500 nm, requires 15 separate excitation wavelengths. Increasing the long wavelength cutoff to 600 nm requires an additional 5 wavelengths, for a total of 20.

Another approach, which has been often used in the past, is to simply pick a single excitation wavelength which is easy to generate (e.g. 266 nm, generated by frequency-quadrupled YAG lasers) and tolerate whatever false alarm performance ensues. Recently, however, new sources at UV wavelengths (e.g. LEDs and laser diodes) eliminate some of the practical constraints on choice of wavelengths, and permit performance to become a more important factor in wavelength selection.

Accordingly, there exists a need for methods and systems for choosing a set of excitation wavelengths that are best suited for use in optical detection of agents in the presence of interferents, e.g., a small subset of a set of wavelengths that are optimal for spectrally separating agents from interferents. There exists also a need for such methods and systems that can be implemented subject to certain constraints, such as cost and manufacturability.

### SUMMARY

The present invention generally presents methods and systems for selecting a set of interrogation wavelengths for use, e.g., in an optical detection technique. In some embodiments, the methods are employed to select an optimal set of wavelengths, where the term “optimal” as used herein can denote, e.g., the fewest wavelengths that will achieve a given performance goal, and/or the best wavelengths when design and/or cost considerations limit the number of excitation wavelengths to relatively few (e.g., three, four, or five, rather than the 15 or 20 mentioned above).

In one exemplary embodiment of the invention, corresponding to detection of, e.g. bio-agents via fluorescence excitation and emission, initially, a set of desired agents can be chosen, e.g., by referring to published literature and selecting agents of interest (e.g. bio warfare agents such as anthrax, plague, various toxins). More often, simulants (i.e. non-lethal substitutes with similar properties) can be used in place of actual agents, for safety reasons. In the following discussion, the set of agents and/or their simulants is referred to as {Aᵢ}. Background substances in the environment that can cause false alarms are known as “interferents.” The set of interferents is herein referred to as {Iᵢ}.

Subsequently, fluorescence EXcitation-EMission spectra and fluorescence Lifetime measurements (herein referred to as XML measurements) can be acquired at several concentrations and in several replicates from the {Aᵢ} and {Iᵢ}. The XML measurements are converted into principal component (PC) space, and the spectral angles of the agents and interferents are calculated The difference between two analytes (and hence the ability to differentiate them) can be quantified by how far apart their respective vectors are. As such, the spectral angles can be employed as a measure or metric of the analytical power of any collection of interrogation wavelengths. Specifically, considering the agents and interferents, the minimum spectral angle SAₘᵢₙ between members of the set of interferents {Iᵢ} and members of the set of agents/simulants {Aᵢ} can be calculated. The wavelengths that maximize SAₘᵢₙ can be identified as the optimal set of interrogation wavelengths, as those wavelengths provide the best separation between agents and interferents.

In one aspect, a method for optical interrogation of a sample is disclosed that includes performing a principal component transformation on a set of spectral data obtained by utilizing a plurality of radiation wavelengths for at least one agent and at least one interferent, and defining a metric based on the principal component transformation to rank order the wavelengths. A subset of the wavelengths having the highest ranks can then be selected and utilized to interrogate a sample.

In a related aspect, the principal component transformation generates one or more principal component vectors for the agent and the interferent. In some embodiments, the metric is defined based on angles between the principal component vectors of the agent and those of the interferent. In other embodiments, the metric is defined based on standard deviations of elements of a transformation matrix associated with the principal component transformation.

The principal component transformation can be performed by applying the transformation to each of a plurality of subsets of the spectral data to generate one or more principal component vectors corresponding to that subset for the agent and the interferent, wherein each subset corresponds to a wavelength grouping. For each data subset, a minimum angle between one or more principal component vectors of the agent and those of the interferent can be determined, and each wavelength grouping can be rank ordered based on the minimum angle associated with its respective data subset, with a grouping having a greater minimum angle attaining a higher rank.

In another aspect, a method for optical detection of agents is disclosed that includes interrogating at least one agent with electromagnetic radiation to generate spectral data corresponding to the agent for each of a plurality of wavelength sets, and interrogating at least one interferent with the plurality of wavelength sets to generate spectral data corresponding to the interferent for each of the wavelength sets. For each of the wavelength sets, a principal component transformation is performed on its respective spectral data so as to generate principal component vectors corresponding to the agent and the interferent. The wavelength sets can then be rank ordered based on a metric indicative of separation of the principal component vectors corresponding to the agent relative to the principal component vectors corresponding to the interferent. By way of example, the metric can be based on angles between the principal component vectors of the agent and the principal component vectors of the interferent, e.g., for each subset of the wavelengths a minimum angle between the principal component vectors of the agent and those of the interferent can be used as the metric.

In another aspect, the invention provides a method of selecting interrogation wavelengths in optical detection of agents, which comprises generating, for each of at least two sets of interrogation wavelengths, a set of principal component vectors for at least an agent and at least an interferent based on spectral data obtained for the agent and the interferent by utilizing the wavelengths in the set. For each set of the principal component vectors, the value of a metric indicative of the separation of the vectors corresponding to the agent relative to the vectors corresponding to the interferent is obtained, and the metric is employed to rank order the sets of the interrogation wavelengths. For example, the metric can be defined as the minimum spectral angle between the principal component vectors of the agent and those of the interferent. A greater rank can be assigned to the wavelength set having a larger minimum angle.

In another aspect, a method of selecting interrogation wavelengths for use in optical detection of agents is disclosed, which comprises interrogating at least one agent and at least one interferent with a plurality of interrogation wavelengths to generate at least one spectral data set. A transformation matrix is obtained for transforming the spectral data set to a plurality of principal component vectors, where each column of the matrix corresponds to one of the vectors. A plurality of standard deviations are then determined each corresponding to a column of the transformation matrix. The standard deviations are then mapped to the plurality of interrogation wavelengths, and the interrogation wavelengths are rank ordered based on the standard deviations.

In a related aspect, in the above method, the step of rank ordering the interrogation wavelengths comprises assigning for any two wavelengths a higher rank to the wavelength associated with a larger standard deviation. A subset of the interrogation wavelengths having higher ranks than those of the remaining wavelengths is selected for use in optical detection of agents.

In another aspect, a system for optical detection of agents is disclosed that can include an interrogation module for obtaining spectral data corresponding to at least one agent and at least one interferent by utilizing a plurality of interrogation wavelengths. The system can further include an analysis module in communication with the interrogation module for receiving the spectral data, where the analysis module performs a principal component transformation on the spectral data. The analysis module utilizes a predefined metric based on the transformation to rank order the interrogation wavelengths.

In some embodiments, the interrogation module in the above system includes a spectrometer, and the analysis module includes a processor configured to perform the principal component transformation. The system can also include a wavelength selection module in communication with the analysis module for receiving the rank ordering of the wavelengths, where the wavelength selection module selects a plurality of wavelengths having the highest ranks.

The system can also include a memory for storing the selection of wavelengths. The interrogation module can communicate with the memory to receive the selection of wavelengths for use in optical interrogation of a sample.

Further understanding of the invention can be obtained by reference to the following detailed description in conjunction with the associated drawings, which are described briefly below.

### BRIEF DESCRIPTION OF THE DRAWINGS

FIG. 1 is a flow diagram depicting various steps in an exemplary embodiment of a method according to the teachings of the invention,

FIGS. 2A-2C show the results of applying the method shown in FIG. 1 to a an exemplary set of {Aᵢ} and {Iᵢ},

FIG. 3 is a flow diagram depicting various steps in exemplary implementations of another embodiment of the invention,

FIG. 4 shows the results of applying the method shown in FIG. 3 to an exemplary set of {Aᵢ} and {Iᵢ}, and

FIG. 5 schematically depicts a system according to an embodiment of the invention.

### DETAILED DESCRIPTION

In the following description, various aspects of the invention are discussed in connection with the detection of biological agents by utilizing their fluorescence spectra. However, the teachings of the invention can be equally applied to any suitable method for spectrally separating agents from interferents, e.g., by utilizing a variety of broad-featured spectra such as those discussed above.

As discussed in more detail below, in many embodiments, a metric is defined based on the transformation of spectral data into the principal component space that will allow selecting a subset of excitation wavelengths that provide optimal separation of agents and interferents. The metric can provide a measure of the separation between the principal component vectors of agents and those of the interferents. By way of example, in some embodiments, the metric can be based on spectral angles between the principal component vectors of the agents and interferents.

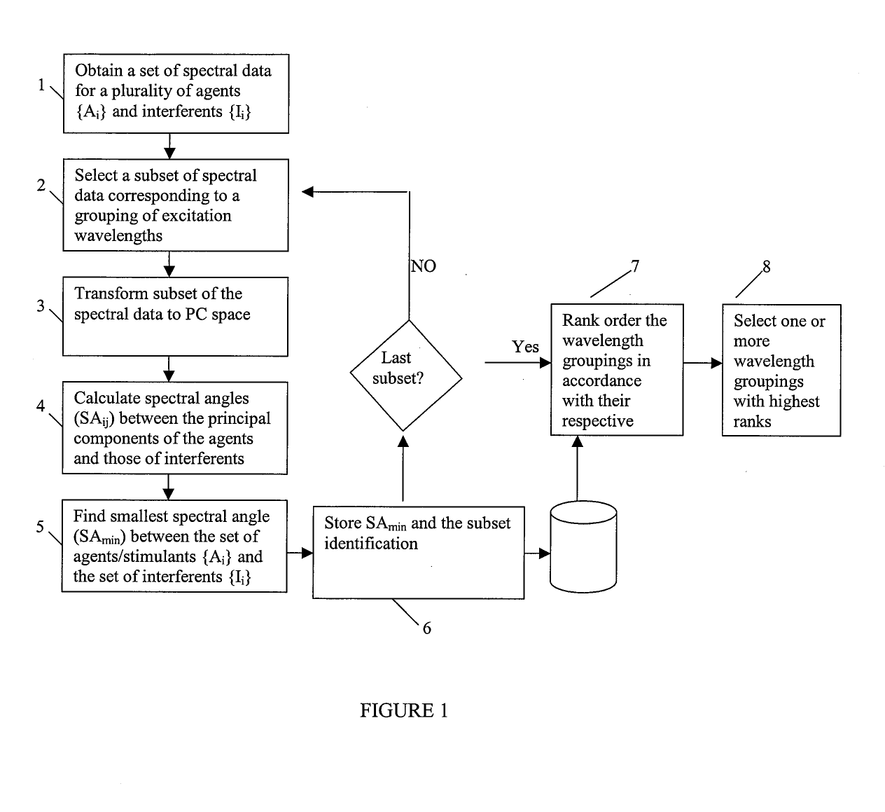

With reference to FIG. 1, in a step (1) of an exemplary embodiment of a method according to the teachings of the invention, a set of spectral data is obtained for a representative sample of agents and/or simulants {Aᵢ} and interferents {Iᵢ}. In this exemplary embodiment, the spectral data correspond to fluorescence excitation-emission spectra and fluorescence lifetime data (herein referred to as XML data or measurements). As noted above, the teachings of the invention can be applied not only to XML data but other types of data, such as, optical reflectance and/or scattering measurements, laser-induced breakdown spectroscopy (LIBS) spectra, Raman spectra, or Terahertz transmission or reflection spectra, etc.

In a subsequent step (2), for each of the agents and interferents, a subset of the spectral data corresponding to a grouping of excitation wavelengths is chosen. The number of wavelengths in each grouping can correspond to the number of optical wavelengths whose selection is desired. For instance, consider a case in which there are 20 excitation wavelengths in a full set of XML data, and the best four wavelengths (i.e., the four wavelengths out of 20 that provide optimal results) need to be identified. As the number of combinations of 20 things (here wavelengths) taken four at a time Cⁿₖ with n=20 and k=4 is 4845, there are 4845 distinct 4-member groupings of the wavelengths. These combinations can be ordered according to some arbitrary scheme, pick the first one, and move to step (3).

In step (3), a principal component transformation is applied to this subset of the data corresponding to a respective wavelength grouping to transform the data in each subset into the principal component (PC) space. The calculation of the principal component transformation can be performed, e.g., according to the teachings of copending patent application entitled “Agent Detection in the Presence of Background Clutter,” having a Ser. No. 11/541,935 and filed on Oct. 2, 2006, which is herein incorporated by reference in its entirety. The principal component analysis can provide an eigenvector decomposition of the spectral data vector space, with the vectors (the “principal components”) arranged in the order of their eigenvalues. There are generally far fewer meaningful principal components than nominal elements in the data vector (e.g., neighboring fluorescence wavelengths can be typically highly correlated). In many embodiments, only meaningful PC vectors are retained. Many ways to select those PC vectors to be retained are known in the art. For example, a PC vector can be identified as meaningful is multiple measurements of the same sample (replicates) continue to fall close together in the PC space. In many bio-aerosol embodiments, the number of meaningful PC vectors can be on the order of 7-9, depending on the exact nature of the data set.

The principal component transformation of the subset of spectral data corresponding to an agent or an interferent generates a principal component vector for that agent or interferent associated with that subset of data and its respective excitation wavelengths. In this manner, for the wavelength grouping, a set of principal component vectors are generated for the agents {Aᵢ} and a set of principal component vectors are generated for the interferents {Iᵢ}.

In step (4), for the selected wavelength grouping, spectral angles (SAᵢⱼ) (index i refers to agents and j to interferents) between the principal component vectors of the agents and those of the interferents, obtained as discussed above by applying a principal component transformation to the spectral data associated with that wavelength grouping, are calculated. By way of example, the spectral angle between two such principal component vectors a and b (that is, between an agent vector and an interferent vector) can be defined by utilizing the normalized dot product of the two vectors as follows:

$$SA ( a , b ) = {cos}^{- 1} [ \frac{a \cdot b}{\vert a \vert \vert b \vert} ] \qquad Eq . ( 1 )$$

wherein

a.b represents the dot product of the two vectors,

|a| and |b| represent, respectively, the length of the two vectors

In many cases the principal component vectors are multi-dimensional and the above dot product of two such vectors (a and b) is calculated in a manner known in the art and in accordance with the following relation:

a.b=a₁b₁+a₂b₂+ . . . +aₙbₙ Eq. (2)

wherein

(a₁, a₂, . . . , aₙ) and (b₁, b₂, . . . , bₙ) refer to the components of the a and b vectors, respectively.

Further, the norm of such a vector (a) can be defined in accordance with the following relation:

|a|=\sqrt{|a₁|²+|a₂|²+ . . . +|aₙ|²} Eq. (3)

Further details regarding the calculation of spectral angles between principal component vectors can be found in the aforementioned patent application entitled “Agent Detection in the Presence of Background Clutter.” This patent application presents a rotation-and-suppress (RAS) method for detecting agents in the presence of background clutter in which such spectral angles act as the metric of separability, with a SA of 90° (orthogonal) corresponding to the easiest separation.

The spectral angles between the agent vectors and the interferent vectors are used herein to define a metric (an objective function) for selecting an optimal grouping of excitation wavelengths. In particular, with continued reference to the flow chart of FIG. 1, in step (5), for the wavelength grouping, the smallest spectral angle between the set of agents and/or simulants {Aᵢ} and the set of interferents {Iᵢ} is chosen as the objective function. The smallest angle, which is herein denoted by SAₘᵢₙ, represents the “worst case scenario,” in the sense of offering the poorest separation between an agent and interferent. The “smallest angle” is herein intended to refer to an angle that is the farthest from orthogonal, so that SAs greater than 90° are replaced by 180°-SA.

In step (6), the SAₘᵢₙ for the data subset is stored, e.g., in a temporary or permanent memory, along with a subset identifier (an identifier that links each subset (distinct wavelength grouping) with a SAₘᵢₙ associated therewith).

The same procedure is repeated for all the other wavelength groupings and their associated data subsets, with the SAₘᵢₙ of each wavelength grouping identified and stored. In many implementations, the calculations of all SAₘᵢₙs can be done via an iterative process (after calculating an SAₘᵢₙ, it is determined whether any additional SAₘᵢₙ(s) need to be calculated, and if so, the calculation(s) is performed—with modern digital computers, an exhaustive search is not prohibitive, although clearly various empirical hill-climbing techniques, genetic algorithms and the like could be used.

Once all the SAₘᵢₙs are calculated (e.g., in the case in which there are 20 excitation wavelengths there would be 4845 SAₘᵢₙs), they can be compared as discussed below to identify the “optimal” wavelength grouping.

In step (7), the wavelength groupings (data subsets) are rank ordered in accordance with their respective SAₘᵢₙs with higher ranks assigned to those having greater SAₘᵢₙs. In other words, for any two wavelength groupings the one that is associated with a greater SAₘᵢₙ is assigned a greater rank. A higher rank is indicative of providing a better spectral separation between the agents and interferents.

In step (8), one or more of the wavelength groupings with the highest ranks can be selected for use as excitation wavelengths in optical detection methods, such as those disclosed in the aforementioned patent application entitled “Agent Detection in the Presence of Background Clutter.” For example, in the above example in which four wavelengths from a list of 20 need to be selected the “best” set of four wavelengths can be computed, in the sense of those that give the best separation between agents and interferents. In some cases, the SAₘᵢₙ computed for the full ensemble of wavelengths (e.g., 20 in the above example) as well as SAₘᵢₙ computed for a subset of the wavelengths (e.g., 4 in the above example) can be utilized to obtain a direct, quantitative measure of the extent by which the selection of the subset of the wavelengths can effect differentiation of agents and interferents in the PC space.

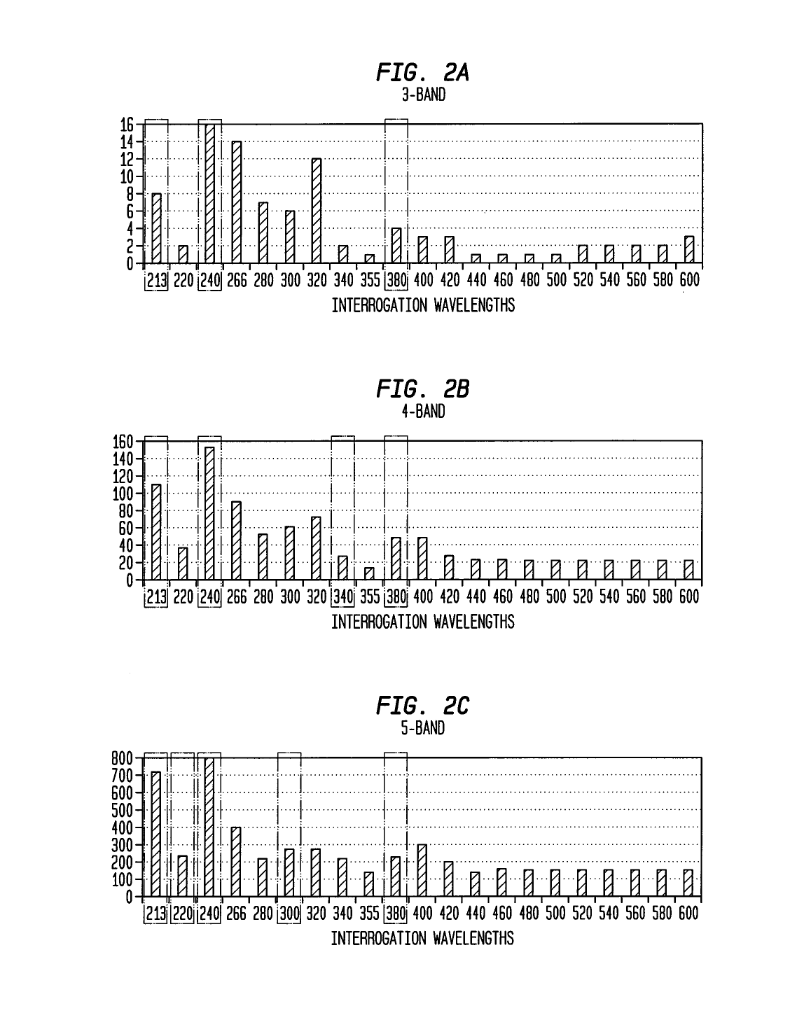

By way of illustration, the results of applying the embodiment of the invention depicted in FIG. 1 to an actual exemplary data set are shown in FIGS. 2A-2C. The data set is small, comprising 4 simulants {Aᵢ} and 4 interferents {Iᵢ}, but it will serve to illustrate the methodology. The results for the best three, four, and five interrogation wavelengths are shown, respectively, in FIGS. 2A, 2B, and 2C. More specifically, the graph is FIG. 2A shows the result for three interrogation wavelengths, labeled “3-Band,” the graph in FIG. 2B the result for four, and the graph in FIG. 2C the result for five interrogation wavelengths. The x axis in each graph shows the interrogation wavelengths, which in this example include 21 wavelengths, extending from 213 nm to 600 nm. For each of the three, four, and five interrogation wavelengths, the combinations are rank-ordered by SAₘᵢₙ, and histograms are plotted of the top 10% of the combination of n wavelengths taken k at a time, where n is 21 and k is (3,4, and 5) in this case. Thus, there will be 3 histogram entries for each combination in the 3-Band case, four for the 4-Band case, and five for the 5-Band case. These histograms give an idea of the robustness of the method, but the largest histogram bins need not correspond to the best SAₘᵢₙ. The actual optimal result is shown in each case as k hollow, diagonally-shaded boxes around the chosen wavelengths. Due to the small size of the data set, the results are not completely stable, and in particular the solution is apparently vacillating between 300 and 340 in the 4- and 5-Band case. However, the general trend is clear, and given the broadness of fluorescence features, wavelengths between 300 and 340 are highly correlated, so that result is not surprising.

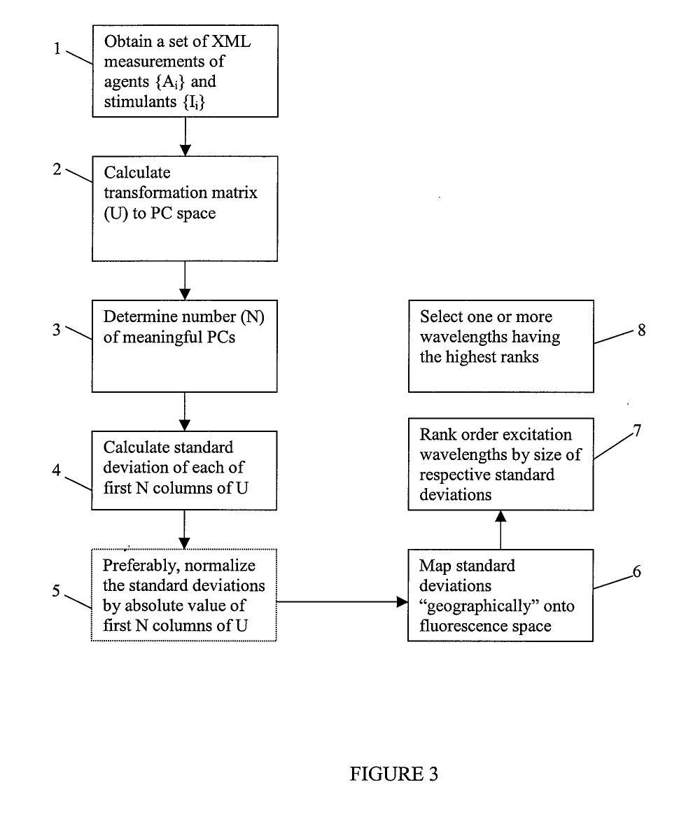

FIG. 3 depicts a flow chart providing various steps of an alternative embodiment of a method according to the invention for selecting an optimal set of interrogation wavelengths. This embodiment has the advantage of being in many cases less computationally intensive than that discussed above in connection with FIG. 1. Considering the transformation of spectral data to PC space: PC=X·U, where X is the spectral data space, U the PC transformation matrix (typically calculated using singular value decomposition), and PC the principal component space. For a given data vector X, there is a matching coefficient U which multiplies it to create a PC vector. Thus, the coefficients making up U can be displayed in the same space as X with a one-to-one mapping. This mapping technique is utilized, e.g., in the field of metrology, where the principal component coefficients are plotted on the geographical grid points from the X data points are taken. Further details of such mapping can be found in “Principal Component Analysis” by I. T. Jolliffe published by Springer-Verlag, New York (1986), which is herein incorporated by reference.

An analogous mapping in fluorescent excitation-emission analysis can be implemented by plotting the U coefficients back “geographically” onto the locations in the two-dimensional excitation-emission fluorescence space. For example, a linear vector X in spectral data space can be unwrapped from the two-dimensional excitation-emission space according to some regular scheme, for instance, by starting at the shortest excitation wavelength and taking all emission wavelengths from the shortest to the longest, then moving to the next shortest excitation wavelength, and so forth. This scheme can be simply inverted to map the columns of U back into the excitation-emission space.

The transformation matrix U will have a column for every meaningful PC (e.g. 7 columns for 7 meaningful PCs in an exemplary data set), and hence 7 re-mapped excitation-emission plots of the coefficients of U exist, one for each PC. In the present embodiment, however, rather than employing the coefficients of U, the standard deviation a of the coefficients (e.g., row-wise, across PC number) are utilized. As discussed above, principal component analysis (PCA) can be employed to reduce the dimensionality of a data set, which can include a large number of interrelated variables, while retaining as much of the variation present in the data set as possible. More specifically, applying a principal component transformation to the data set can generate a new set of variables, the principal components, which are uncorrelated and which are ordered so that the first few retain most of the variation present in all the original variables.

As such, if the underlying spectral data at any single excitation-emission point in X were always constant, then no variation would have to be explained, and the corresponding coefficient of U would be zero for all columns. At the other extreme, if any single excitation-emission point were completely uncorrelated with any other excitation-emission point, then it would itself represent irreducible variation and its weight would appear entirely in one column of U. In the former case, the row-wise standard deviation a of the coefficients would be zero, while in the latter it would be large. Thus, in this embodiment the row-wise standard deviation vector a (with as many rows as U, but only 1 column) is utilized as a metric for the amount of variation exhibited by its corresponding spectral data, although other metrics of variation could also be used, e.g. variance or range.

As the data set in question can be a representative sample of agents and/or simulants {Aᵢ} and interferents {Iᵢ}, plotting the vector σ “geographically” back into excitation-emission space will give a measure of how much each area of the excitation-emission spectrum of that space contributes to discrimination between the agents and the interferent.

FIG. 3 schematically depicts an exemplary implementation of the alternative embodiment for selecting an optimal set of wavelengths. In step (1), a set of XML measurements of a representative sample of agents and/or simulants {Aᵢ} and interferents {Iᵢ} is obtained.

In a subsequent step (2), a transformation matrix (U) for effecting principal component transformation is calculated for the data set, e.g., in a manner discussed above and the data is transformed into that principal component (PC) space. As noted above, further details regarding principal component transformation can be found in the teachings of the aforementioned pending patent application “Agent Detection in the Presence of Background Clutter.” In step (3) the number of meaningful (non-noise) PC vectors is identified. In general, only meaningful PC vectors are retained. In many bio-aerosol fluorescence cases, the retained PC vectors can be on the order of 7-9, depending on the exact nature of the data set. The number of meaningful PCs is herein denoted by N.

In step (4), the standard deviations of the coefficients of the first N columns of transformation matrix U are calculated, as discussed above. In some implementations, The standard deviations are then normalized (step 5), e.g., by the mean value of U to generate fractional standard deviations. In alternative implementations, the normalization step is omitted.

In step (6), the standard deviations are mapped back onto the excitation-emission space, e.g., in a manner discussed above. The excitation wavelengths can be rank ordered (step 7) based on standard deviations, with the wavelengths associated with larger standard deviations attaining greater ranking. The excitation wavelengths that correspond to the largest values of the standard deviations, that is, the one having the highest ranks, are then selected (step 8).

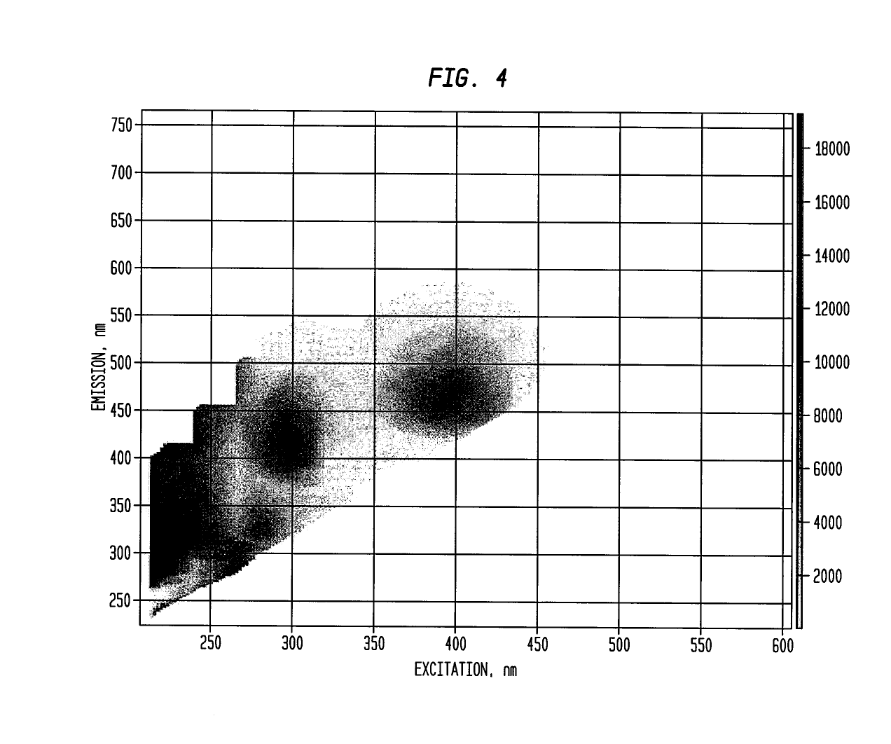

FIG. 4 shows the results of applying the method of the above alternative embodiment discussed with reference to FIG. 3 to the same data set as was used in FIGS. 2A-2C (that is, the output of box 6 in FIG. 3). The row-wise standard deviation of U is shown in grayscale, with black representing the largest values and white the smallest. The bar on the right hand side shows the grayscale corresponding to a given value of a. The excitation wavelengths are represented by the darkest hues (i.e., the ones that are associated with the largest a) are seen to generally correspond to those selected by the method of FIG. 1. However, this method is much less computationally intensive than that of FIG. 1 as it does not require thousands of sets of computations, one for every possible combination.

The methods of the invention can be utilized to select wavelengths for detection of a plurality of agents in the presence of a plurality of interferents. A Government-funded program known as “Bug Trap” collects and classifies potential background interferents from the environment, which can be utilized as interferents in some implementations of the methods of the invention.

Although the discussion above refers particularly to separating classes of agents and interferents in bio-aerosols, it will be apparent to those skilled in the art that the approach taken can be generalized to other analytical methods which generate spectral data, or indeed any data set which consists of a large number of correlated variables whose apparent dimensionality can be reduced by the application of a principal component transformation.

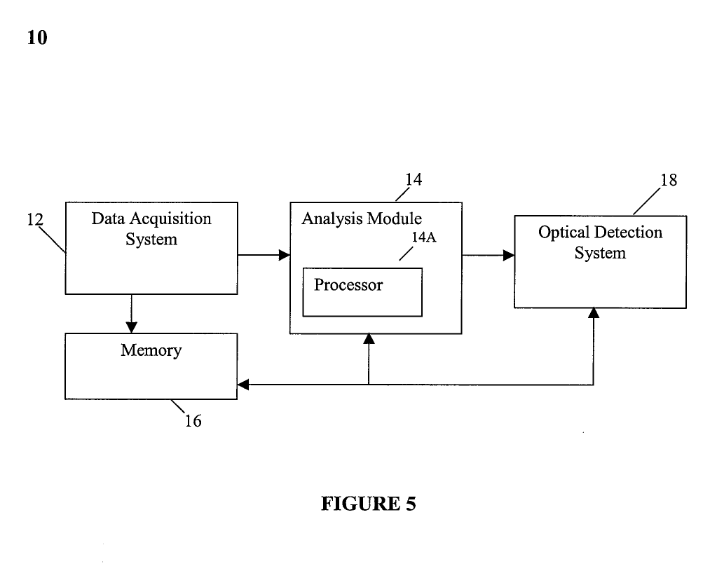

The methods of the invention such as those discussed above can be implemented by utilizing a variety of systems. One such exemplary system 10 shown in FIG. 5 can include a data acquisition module 12 for collecting spectral data corresponding to a set of agents and interferents. By way of example, the data acquisition module can include a spectrometer that is capable of collecting the fluorescence emission spectra as well as the fluorescence lifetime of the agents and the interferents in response to a plurality of excitation wavelengths. The data acquisition module can transmit the spectral data to an analysis module 14 and optionally store the spectral data in a memory 16. While in some cases, the analysis module receives the collected spectral data in real time, in other cases, it can access previously stored spectral data in the memory 16.

The analysis module can include a processor 14a and associated circuitry configured to apply the above methods to the spectral data so as to determine an optimal set of excitation wavelengths. For example, the processor can be programmed in a manner known in the art to apply a principal component transformation to the spectral data and generate a metric based on the transformation for ranking the wavelengths. The analysis module can store the rank ordering of the wavelengths, as well as a set of optimal wavelengths selected based on the rank ordering, in the memory 16 for later use.

In some cases, the analysis module is in communication with an optical detection system 18, which in some cases can be the data acquisition module 12 itself, to inform the system of the optimal set of the excitation wavelengths. In some cases, the analysis module can convey this information to the optical detection system in real time. Alternatively, the optical detection system 18 can access the memory 16 to obtain that information.

The teachings of the following publications are herein incorporated by reference:
T. McCreery, “Spectral Sensing of Bio-Aerosols (SSBA),” available at http://www.darpa.mil/spo/programs/briefing/SSBA.pdf accessed on 27 Mar. 2007
P. C. Trepagnier, P. D. Henshaw, R. F. Dillon, and D. P. McCampbell, “A fluorescent bio-aerosol point detector incorporating excitation, emission, and lifetime data,” Proc. SPIE Vol. 6377, 637708 (2006).
P. D. Henshaw and P. C. Trepagnier, “Real-time Determination and Suppression of Bio-Aerosol Constituents,” Proc SPIE Vol. 6378, 637814 (2006).
P. D. Henshaw and P. C. Trepagnier, “Agent Detection in the Presence of Background Clutter,” U.S. patent application Ser. No. 11/541,935, filed on Oct. 2, 2006, and references contained therein.
I. T. Jolliffe, Principal Component Analysis, Springer-Verlag, New York, 1986.

Those having ordinary skill in the art will appreciate that various modifications can be made to the above embodiments without departing from the scope of the invention.

1. A method for optical interrogation of a sample, comprising:
performing a principal component transformation on a set of spectral data obtained by utilizing a plurality of radiation wavelengths for at least one agent and at least one interferent,
defining a metric based on said principal component transformation to rank order said wavelengths,
selecting a subset of said wavelengths having the highest ranks, and
utilizing the wavelengths in said selected subset to interrogate a sample.

2. The method of claim 1, wherein said principal component transformation generates one or more principal component vectors for said agent and said interferent.

3. The method of claim 2, wherein said metric is based on angles between said principal component vectors of said agent and those of said interferent.

4. The method of claim 1, wherein said metric is based on standard deviations of elements of a transformation matrix corresponding to said principal component transformation.

5. The method of claim 3, wherein the step of performing the principal component transformation comprises applying the transformation to each of a plurality of subsets of the data to generate one or more principal component vectors corresponding to that subset for the agent and the interferent, wherein each subset corresponds to a wavelength grouping.

6. The method of claim 5, further determining for each data subset a minimum angle between one or more principal component vectors of the agent and those of the interferent.

7. The method of claim 6, further comprising rank ordering each wavelength grouping based on the minimum angle associated with its respective data subset.

8. A method for optical detection of agents, comprising
interrogating at least one agent with electromagnetic radiation to generate spectral data corresponding to said agent for each of a plurality of wavelength sets,
interrogating at least one interferent with said plurality of wavelength sets to generate spectral data corresponding to said interferent for each of said wavelength sets,
for each of said wavelength sets, performing a principal component transformation on its respective spectral data so as to generate principal vectors corresponding to said agent and said interferent, and
rank ordering said wavelength sets based on a metric indicative of separation of the principal component vectors corresponding to said agent relative to the principal component vectors corresponding to said interferent.

9. The method of claim 8, further comprising selecting one or more of said wavelength sets with ranks greater than those of other wavelength sets.

10. The method of claim 8, wherein said metric is based on angles between said principal component vectors of the agent and said principal component vectors of the interferent.

11. The method of claim 10, wherein said step of rank ordering comprises determining for each of a plurality of subsets of said wavelengths a minimum angle between the principal component vectors of the agent and the principal component vectors of the interferent derived from spectral data corresponding to said subset.

12. The method of claim 11, further comprising assigning a higher rank to a subset providing a larger minimum angle.

13. A method of selecting interrogation wavelengths in optical detection of agents, comprising
for each of at least two sets of interrogation wavelengths, generating a set of principal component vectors for at least an agent and at least an interferent based on spectral data obtained for said agent and said interferent by utilizing the wavelengths in the set,
for each set of the principal component vectors, obtaining value of a metric indicative of separation of the vectors corresponding to the agent relative to the vectors corresponding to the interferent, and
utilizing said metric values to rank order said sets of the interrogation wavelengths.

14. The method of claim 13, wherein said metric comprises a minimum spectral angle between the principal component vectors of said agent and those of said interferent.

15. The method of claim 14, further comprising assigning a greater rank to the wavelength set having a larger minimum angle.

16. The method of claim 13, wherein said agent comprises any of a pathogen and a toxic substance.

17. The method of claim 13, further comprising interrogating the agent and the interferent with the radiation wavelengths in said sets so as to generate said agent and interferent spectral data.

18. The method of claim 17, wherein the step of interrogating any of the agent and the interferent comprises obtaining a fluorescence emission spectrum thereof.

19. The method of claim 17, wherein the step of interrogating any of the agent and the interferent comprises obtaining a transmission spectrum thereof.

20. The method of claim 17, wherein the step of interrogating any of the agent and the interferent comprises obtaining a reflection spectrum thereof.

21. A method of selecting interrogation wavelengths for use in optical detection of agents, comprising
interrogating at least one agent and at least one interferent with a plurality of interrogation wavelengths to generate at least one spectral data set,
obtaining a transformation matrix for transforming said spectral data set to a plurality of principal component vectors, wherein each column of said matrix corresponds to one of said vectors,
determining a plurality of standard deviations each corresponding to a column of said transformation matrix,
mapping said standard deviations to said plurality of interrogation wavelengths, and
rank ordering said interrogation wavelengths based on said standard deviations.

22. The method of claim 21, wherein the step of rank ordering the interrogation wavelengths comprises assigning for any two wavelengths a higher rank to the wavelength associated with a larger standard deviation.

23. The method of claim 22, further comprising selecting a subset of said interrogation wavelengths having higher ranks than the remaining wavelengths for use in optical detection of wavelengths.

24. A system for optical detection of agents, comprising
an interrogation module for obtaining spectral data corresponding to at least one agent and at least one interferent by utilizing a plurality of interrogation wavelengths,
an analysis module in communication with said interrogation module for receiving said spectral data, said analysis module performing a principal component transformation on said spectral data,
wherein said analysis module utilizes a predefined metric based on said transformation to rank order said interrogation wavelengths.

25. The system of claim 24, wherein said interrogation module comprises a spectrometer.

26. The system of claim 24, wherein said analysis module comprises a processor configured to perform said principal component transformation.

27. The system of claim 24, further comprising a wavelength selection module in communication with said analysis module for receiving said rank ordering of the wavelengths, said selection module selecting a plurality of wavelengths having the highest ranks.

28. The system of claim 27, further comprising a memory for storing said selection of wavelengths.

29. The system of claim 28, wherein said interrogation module is in communication with the memory to receive said selection of wavelengths for use in optical interrogation of a sample.
